(19) United States
(12) Patent Application Publication
(10) Pub. No.: US 2021/0083317 A1
(43) Pub. Date: Mar. 18, 2021

(54) LITHIUM ION CONDUCTIVE COMPOSITE MATERIAL FOR ALL SOLID-STATE LITHIUM BATTERY, AND SOLID POLYMER ELECTROLYTE AND ALL SOLID-STATE LITHIUM BATTERY INCLUDING THE SAME

(71) Applicant: Ming Chi University of Technology, New Taipei City (TW)

(72) Inventors: Chun-Chen Yang, New Taipei City (TW); Yi-Shiuan Wu, New Taipei City (TW); Hoai-Khang Tran, New Taipei City (TW); Min-Zen Lee, New Taipei City (TW)

(21) Appl. No.: 16/671,442

(22) Filed: Nov. 1, 2019

(30) Foreign Application Priority Data
Sep. 12, 2019 (TW) 108132925

(51) Int. Cl. H01M 10/056; H01M 10/0525

(52) U.S. Cl. CPC H01M 10/056; H01M 10/0525; H01M 2300/0071; H01M 2300/0082; H01M 2300/0091

(57) ABSTRACT

A lithium ion conductive composite material for an all solid-state lithium battery includes a polymer blend, a lithium salt, a lithium ion conductive ceramic filler, and a plasticizer. The polymer blend includes polyacrylonitrile and a polyvinyl polymer selected from the group consisting of polyvinyl alcohol, poly(vinylidene fluoride-hexafluoropropylene), and a combination thereof.

### CROSS-REFERENCE TO RELATED APPLICATION

This patent application claims priority of Taiwanese Patent Application No. 108132925, filed on Sep. 12, 2019.

### FIELD

The disclosure relates to a lithium ion conductive composite material, and more particularly to a lithium ion conductive composite material for an all solid-state lithium battery. The disclosure also relates to a solid polymer electrolyte and an all solid-state lithium battery which include the lithium ion conductive composite material.

### BACKGROUND

Lithium ion battery has properties such as a high open circuit voltage, a high energy density, a fast charge/discharge rate, a long charge/discharge cycle life, a low self-discharge, and lightweight, and is commonly used as an energy saving device and a power supplying device for consumer electronic products, transportation facilities, etc. However, liquid electrolyte contained in the lithium ion battery is volatile and flammable, and might have adverse effects on the safety of a user. In addition, lithium dendrite is easily formed after several charge/discharge cycles, which in turn might cause a short circuit of the lithium ion battery.

Although currently available all solid-state lithium battery includes a solid-state electrolyte composite membrane that can prevent safety problems associated with the lithium ion battery, such as leakage of the liquid electrolyte and growth of the lithium dendrite, a high interfacial resistance might be easily produced due to poor interfacial contact between the solid-state electrolyte composite membrane and the electrodes of the all solid-state lithium battery. In addition, the solid-state electrolyte composite membrane generally has low lithium ion conductivity (for example, in an order of 10⁻⁷ S/cm) at room temperature, and thus, cannot provide the all solid-state lithium battery with superior performance.

### SUMMARY

Therefore, a first object of the disclosure is to provide a lithium ion conductive composite material for an all solid-state lithium battery to overcome the shortcomings described above.

A second object of the disclosure is to provide a solid polymer electrolyte, which includes the lithium ion conductive composite material, for an all solid-state lithium battery.

A third object of the disclosure is to provide an all solid-state lithium battery which includes a lithium ion conductive layer including the lithium ion conductive composite material.

According to a first aspect of the disclosure, there is provided a lithium ion conductive composite material for an all solid-state lithium battery. The lithium ion conductive composite material includes a polymer blend, a lithium salt, a lithium ion conductive ceramic filler, and a plasticizer. The polymer blend includes polyacrylonitrile and a polyvinyl polymer selected from the group consisting of polyvinyl alcohol, poly(vinylidene fluoride-hexafluoropropylene), and a combination thereof.

According to a second aspect of the disclosure, there is provided a solid polymer electrolyte for an all solid-state lithium battery. The solid polymer electrolyte includes the lithium ion conductive composite material of the first aspect of the disclosure.

According to a third aspect of the disclosure, there is provided an all solid-state lithium battery, which includes an anode, a cathode, a solid electrolyte composite membrane, and a lithium ion conductive layer. The solid electrolyte composite membrane is disposed between the anode and the cathode. The lithium ion conductive layer includes the lithium ion conductive composite material of the first aspect of the disclosure, and is applied on at least one of the anode and the cathode so as to be sandwiched between the solid electrolyte composite membrane and the at least one of the anode and the cathode.

### BRIEF DESCRIPTION OF THE DRAWINGS

Other features and advantages of the disclosure will become apparent in the following detailed description of the embodiment (s) with reference to the accompanying drawings, of which:

FIG. 1 is a graph illustrating thermogravimetric analysis results of polyvinyl alcohol (PVA), a polymer blend of polyvinyl alcohol and polyacrylonitrile (PVA/PAN), and a solid polymer electrolyte composite membrane (SPE1) sample of Example 1;

FIG. 2 is a graph illustrating a potential-current relationship of SPE1 sample of Example 1 determined by linear sweep voltammetry;

FIG. 3 is a schematic exploded perspective view of an all solid-state lithium battery of each of Application Examples 1 to 7 and Comparative Application Examples 2 and 3;

FIG. 4 is a schematic exploded perspective view of an all solid-state lithium battery of Application Example 8;

FIG. 5 is a schematic exploded perspective view of a lithium ion battery of Comparative Application Example 1; and

FIG. 6 depicts graphs illustrating charge/discharge specific capacity-potential relationship for the all solid-state lithium battery of Application Example 1 for 3 charge/discharge cycles, in which graph (a) represents the result determined at 25° C., and graph (b) represents the result determined at 60° C.

### DETAILED DESCRIPTION

A lithium ion conductive composite material for an all solid-state lithium battery according to the disclosure includes a polymer blend, a lithium salt, a lithium ion conductive ceramic filler, and a plasticizer. The polymer blend includes polyacrylonitrile and a polyvinyl polymer selected from the group consisting of polyvinyl alcohol, poly(vinylidene fluoride-hexafluoropropylene), and a combination thereof.

In certain embodiments, the polyacrylonitrile is in an amount ranging from 5 wt % to 95 wt % and the polyvinyl polymer is in an amount ranging from 95 wt % to 5 wt % based on 100 wt % of the polymer blend.

In certain embodiments, the polyvinyl polymer is polyvinyl alcohol, and the polyacrylonitrile is in an amount ranging from 5 wt % to 20 wt % and the polyvinyl alcohol is in an amount ranging from 95 wt % to 80 wt % based on 100 wt % of the polymer blend. In some examples illustrated below, the polyacrylonitrile is in an amount of 7.5 wt % and the polyvinyl alcohol is in an amount of 92.5 wt % based on 100 wt % of the polymer blend.

In certain embodiments, the polyvinyl polymer is poly(vinylidene fluoride-hexafluoropropylene), and the polyacrylonitrile is in an amount ranging from 5 wt % to 20 wt % and the poly(vinylidene fluoride-hexafluoropropylene) is in an amount ranging from 95 wt % to 80 wt % based on 100 wt % of the polymer blend. In some examples illustrated below, the polyacrylonitrile is in an amount of 10 wt % and the poly(vinylidene fluoride-hexafluoropropylene) is in an amount of 90 wt % based on 100 wt % of the polymer blend.

In certain embodiments, the polymer blend is in an amount ranging from 30 wt % to 40 wt % based on 100 wt % of a combination of the polymer blend, the lithium salt, and the lithium ion conductive ceramic filler. In examples illustrated below, the polymer blend is in an amount of 40 wt % based on 100 wt % of the combination of the polymer blend, the lithium salt, and the lithium ion conductive ceramic filler.

In certain embodiments, the lithium salt is in an amount ranging from 30 wt % to 50 wt % based on 100 wt % of the combination of the polymer blend, the lithium salt, and the lithium ion conductive ceramic filler. In examples illustrated below, the lithium salt is in an amount of 40 wt % based on 100 wt % of the combination of the polymer blend, the lithium salt, and the lithium ion conductive ceramic filler.

In certain embodiments, the lithium ion conductive ceramic filler is in an amount ranging from 1 wt % to 30 wt % based on 100 wt % of the combination of the polymer blend, the lithium salt, and the lithium ion conductive ceramic filler. In examples illustrated below, the lithium ion conductive ceramic filler is in an amount of 20 wt % based on 100 wt % of the combination of the polymer blend, the lithium salt, and the lithium ion conductive ceramic filler.

In certain embodiments, the plasticizer is in an amount ranging from 1 wt % to 40 wt % based on 100 wt % of the polymer blend. In examples illustrated below, the plasticizer is in an amount of 10 wt % based on 100 wt % of the polymer blend.

In certain embodiments, the lithium salt is selected from the group consisting of lithium bis-trifluoromethanesulfonimide (LiTFSI), lithium perchlorate (LiClO₄), lithium trifluoromethanesulfonate (CF₃SO₃Li), lithium bis(oxalato)borate (LiBOB), lithium tetrafluoroborate (LiBF₄), and combinations thereof. In some examples illustrated below, LiTFSI is used as the lithium salt, and in some other examples illustrated below, LiClO₄ is used as the lithium salt.

In certain embodiments, the lithium ion conductive ceramic filler is selected from the group consisting of lithium aluminum titanium phosphate (LATP), lithium aluminum germanium phosphate (LAGP), lithium lanthanum zirconium oxide (LLZO), aluminum-doped lithium lanthanum zirconium oxide (Al-LLZO), gallium-doped lithium lanthanum zirconium oxide (Ga-LLZO), niobium-doped lithium lanthanum zirconium oxide (Nb-LLZO), lithium lanthanum zirconium tantalum oxide (LLZTO), lithium lanthanum titanium oxide (LLTO), lithium phosphorous oxynitride (LiPON), and combinations thereof. In some examples illustrated below, LATP is used as the lithium ion conductive ceramic filler, and in some other examples illustrated below, Al-LLZO is used as the lithium ion conductive ceramic filler.

The plasticizer is used to enhance dissociation of the lithium salt. In certain embodiments, the plasticizer is selected from the group consisting of succinonitrile (SN), adiponitrile, lithium azide (LiN₃), poly(ethylene glycol) (PEG), poly(ethylene glycol) diacrylate (PEGDA), triallyl isocyanurate (TAIC), and combinations thereof. In examples illustrated below, succinonitrile is used as the plasticizer.

A solid polymer electrolyte for an all solid-state lithium battery according to the disclosure includes the lithium ion conductive composite material as described above.

An all solid-state lithium battery according to the disclosure includes an anode, a cathode, a solid electrolyte composite membrane, and a first lithium ion conductive layer. The solid electrolyte composite membrane is disposed between the anode and the cathode. The first lithium ion conductive layer includes the lithium ion conductive composite material as described above, and is applied on one of the anode and the cathode so as to be sandwiched between the solid electrolyte composite membrane and the one of the anode and the cathode.

In certain embodiments, the all solid-state lithium battery further includes a second lithium ion conductive layer which includes the lithium ion conductive composite material as described above, and which is applied on the other one of the anode and the cathode so as to be sandwiched between the solid electrolyte composite membrane and the other one of the anode and the cathode.

In certain embodiments, the solid electrolyte composite membrane is the solid polymer electrolyte as described above.

In certain embodiments, the cathode is made of a composition including an active material, an electron-conductive agent, and a binder. Examples of the active material include, but are not limited to, lithium-containing multinary compounds such as lithium iron phosphate (LFP), lithium manganese phosphate (LMP), lithium iron manganese phosphate (LFMP), lithium iron manganese cobalt phosphate (LFMCP), lithium vanadium phosphate (LVP), lithium nickel cobalt aluminum oxide (LNCAO), lithium nickel cobalt manganese oxide (LNCMO), lithium nickel manganese oxide (LNMO), lithium cobalt oxide (LCO), and lithium-rich oxide. In an example illustrated below, LFP, LNCAO, and LNCMO are used as the active material. Examples of the electron-conductive agent include, but are not limited to, conductive carbon black, vapor grown carbon fibers (VGCF), and multi-wall carbon nanotube (MWCNT). A non-limiting example of the binder is a mixture solution containing the polymer blend (for example, PVA/PAN), the lithium salt (for example, LiTFSI), the lithium ion conductive ceramic filler (for example, LATP), and the plasticizer (for example, SN) as described above. In some examples illustrated below, the composition for making the cathode further includes lithium ion substituted Nafion (denoted as Li-Nafion).

In certain embodiments, the anode is made of a lithium-containing material selected from a lithium metal, a lithium alloy, and a combination thereof. In examples illustrated below, the anode is made of a lithium metal.

Examples of the disclosure will be described hereinafter. It is to be understood that these examples are exemplary and explanatory and should not be construed as a limitation to the disclosure.

Before the examples of the disclosure are described in greater detail, it should be noted that where considered appropriate, reference numerals or terminal portions of reference numerals have been repeated among the figures to indicate corresponding or analogous elements, which may optionally have similar characteristics.

### Example 1: Preparation of a Lithium Ion Conductive Composite Material and a Solid Polymer Electrolyte

Polyvinyl alcohol (PVA, M_{w}=8.9×10⁵, commercially available from Sigma-Aldrich) was mixed with polyacrylonitrile (PAN, M_{w}=1.5×10⁵, commercially available from Sigma-Aldrich) in a weight ratio of PVA to PAN of 92.5:7.5 to obtain a polymer blend (PVA/PAN). The polymer blend (PVA/PAN) was mixed with lithium bis-trifluoromethanesulfonimide (LiTFSI, commercially available from Sigma-Aldrich), followed by dissolution in dimethyl sulfoxide (DMSO, commercially available from Sigma-Aldrich) as a solvent to obtain a mixture solution in DMSO. After that, lithium aluminum titanium phosphate (LATP) and succinonitrile (SN, commercially available from Sigma-Aldrich) were added to the mixture solution in DNSO under stirring in a weight ratio of PVA/PAN to LiTFSI to LATP to SAN of 4:4:2:0.4, followed by heating to a temperature of 80° C. and maintaining the temperature under stirring for 24 hours, so as to obtain a lithium ion conductive composite mixture in a solution form.

The lithium ion conductive composite mixture in the solution form was stirred evenly, and then applied on a glass substrate, followed by drying at 25° C. for 24 hours, and was further dried under vacuum at 70° C. for 72 hours to fully evaporate the DMSO solvent, so as to obtain a solid polymer electrolyte composite membrane (SPE1) sample having a thickness of about 100 μm to 200 μm.

The solid polymer electrolyte composite membrane (SPE1) sample that had been subjected to complete drying was cut to obtain a circular composite membrane having a diameter of 18 mm. The circular composite membrane was stored under an argon atmosphere.

### Example 2: Preparation of a Lithium Ion Conductive Composite Material and a Solid Polymer Electrolyte

Lithium nitrate (LiNO₃, commercially available from Alfa Aesar), aluminum nitrate (Al(NO₃)₃.9H₂O, commercially available from Alfa Aesar), and lanthanum nitrate (La(NO₃)₃.6H₂O, commercially available from Alfa Aesar) were mixed in deionized water under stirring for 30 minutes, in a molar ratio of lithium nitrate to aluminum nitrate to lanthanum nitrate of 6.25:0.25:3, so as to obtain a first solution.

Zirconium tetrapropoxide (a 70 wt % solution in propanol, commercially available from Sigma-Aldrich) was dissolved in a solution of 15 vol % of acetic acid in isopropanol, such that a molar ratio of La to Zr was 3:2, followed by addition of an excess amount of lithium nitrate until a concentration thereof was 15 wt % to compensate lithium loss during sintering at an elevated temperature, thereby obtaining a second solution.

The first solution was mixed with the second solution under stirring for 30 minutes to obtain a mixture solution of aluminum-doped lithium lanthanum zirconium oxide (Al-LLZO). A graphite nanofiber mat was immersed in the solution of Al-LLZO for 12 hours. Thereafter, the graphite nanofiber mat was removed from the mixture solution of Al-LLZO, dried at 90° C. for 12 hours, and heated in air at a heating rate of 2° C./min to a temperature of 800° C., followed by sintering at the temperature for 2 hours, so as to obtain a powdery material of Al-LLZO (Li_{6.25}Al_{0.25}La₃Zr₂O₁₂) as a lithium ion ceramic filler.

Lithium perchlorate (LiClO₄, commercially available from Alfa Aesar) was mixed with poly(vinylidene fluoride-hexafluoropropylene) (PVDF-HFP, M_{w}=4×10⁵, commercially available from Sigma-Aldrich) in N,N-dimethylforamide (DMF, commercially available from Sigma-Aldrich) solvent under stirring for 12 hours at 60° C. in a weight ratio of LiClO₄ to PVDF-HFP of 1:1.8, so as to obtain a first mixture (LiClO₄/PVDF-HFP) solution.

Polyacrylonitrile (PAN), the powdery material of Al-LLZO, and succinonitrile (SN) were all mixed in DMF under stirring at 60° C. for 12 hours in a weight ratio of PAN to Al-LLZO to SN of 0.2:0.75:0.2, so as to obtain a second mixture (PAN/Al-LLZO/SN) solution.

The first mixture solution was mixed with the second mixture solution under stirring for 1 hour, followed by milling using a ball mill (commercially available from Fritsch GmbH, Germany) at a rate of 400 rpm for 5 hours, so as to obtain a lithium ion conductive composite material as a mixed solution.

The lithium ion conductive composite material was applied on a glass substrate, followed by drying at 25° C. for 12 hours, and further drying under vacuum at 80° C. for 48 hours to obtain a solid polymer electrolyte composite membrane (SPE2) sample. The solid polymer electrolyte composite membrane sample that had been subjected to complete drying was punched to obtain a circular composite membrane having a diameter of 18 mm and a thickness of about 100 μm to 200 μm.

### Example 3: Preparation of a Lithium Ion Conductive Composite Material and a Solid Polymer Electrolyte

PVA, the powdery material of Al-LLZO of Example 2, and LiTFSI were mixed and dissolved in DNSO solvent to obtain a first mixture (PVA/Al-LLZO/LiTFSI) solution. PAN and SN were mixed and dissolved in DMSO solvent to obtain a second mixture (PAN/SN) solution.

The first mixture solution was mixed with the second mixture solution such that a weight ratio of PVA to PAN was 92.5:7.5, and that a weight ratio of (PVA+PAN) to LiTFSI to Al-LLZO to SN was 4:4:2:0.4, followed by heating to a temperature of 80° C., maintaining at the temperature under stirring for 24 hours, and then milling using a ball mill at a rate of 400 rpm for 2 hours, so as to obtain a lithium ion conductive composite mixture as a mixed solution.

The lithium ion conductive composite mixture as the mixed solution was applied on a glass substrate, followed by drying at 25° C. for 24 hours, and further drying under vacuum at 70° C. for 72 hours to obtain a solid polymer electrolyte composite membrane (SPE3) sample. The solid polymer electrolyte composite membrane sample that had been subjected to complete drying was punched to obtain a circular composite membrane having a diameter of 18 mm and a thickness of about 100 μm to 200 μm.

### Thermogravimetric Analysis (TGA):

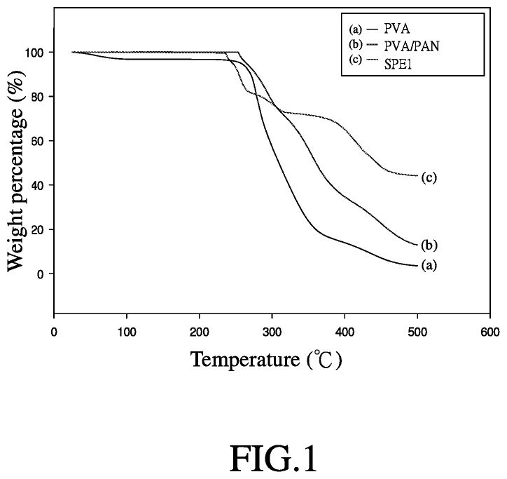

The weights of PVA, PVA/PAN, and the SPE1 sample of Example 1 as a function of temperature were measured by thermogravimetry under a nitrogen atmosphere. The results are shown in FIG. 1.

As shown in FIG. 1, the weight loss ratios of PVA and PVA/PAN after a heating procedure that was conducted from 25° C. to 500° C. were 93.1% and 86.3%, respectively. In comparison, the weight loss ratio of the SPE1 sample after the heating procedure is only 54.8%. It is indicated that the SPE1 sample has superior thermal stability.

### Measurement of Lithium Ion Conductivity:

A solid polymer electrolyte composite membrane (SPE1′) sample was prepared according to the procedure for preparing the SPE1 sample, except that the weight ratio of PVA/PAN to LiTFSI to LATP to SAN was changed to 4:4:2:0. Another solid polymer electrolyte composite membrane (SPE1″) sample was also prepared according to the procedure for preparing the SPE1 sample, except that the weight ratio of PVA/PAN to LiTFSI to LATP to SAN was changed to 4:3:3:0. Lithium ion conductivities of the SPE1, SPE1′, and SPE1″ samples were measured at a temperature ranging from 25° C. to 80° C. by AC impedance spectroscopy. The results are shown in Table 1 below.

TABLE 1

| | Temperature (° C.) | | | | | |
|---|---|---|---|---|---|---|
| Sample | 25 | 40 | 50 | 60 | 70 | 80 |
| SPE1 | 9.53 × 10⁻⁵ | 2.37 × 10⁻⁴ | 4.10 × 10⁻⁴ | 5.40 × 10⁻⁴ | 6.90 × 10⁻⁴ | 8.44 × 10⁻⁴ |
| SPE1 ′ | 6.72 × 10⁻⁶ | 1.89 × 10⁻⁵ | 4.87 × 10⁻⁵ | 8.82 × 10⁻⁵ | 1.17 × 10⁻⁴ | 1.51 × 10⁻⁴ |
| SPE1″ | 6.27 × 10⁻⁷ | 1.16 × 10⁻⁶ | 2.24 × 10⁻⁶ | 4.84 × 10⁻⁶ | 8.36 × 10⁻⁶ | 1.15 × 10⁻⁵ |

As shown in Table 1, at the same temperature range, the lithium ion conductivity of the SPE1 sample of Example 1 is significantly higher than those of the SPE′ and SPE″ samples, which do not include SN.

In addition, the lithium ion conductivities of the SPE2 and SPE3 samples of Examples 2 and 3 at 25° C. were measured to be about 1.19×10⁻⁴ S/cm and 1.17×10⁻⁴ S/cm, respectively.

### Analysis of Linear Sweep Voltammetry (LSV):

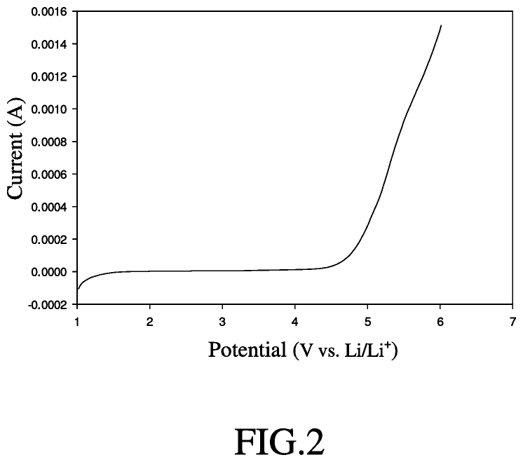

The SPE1 sample of Example 1 was subjected to linear sweep voltammetry analysis at a sweep rate of 1.0 mV/s and a sweep potential ranging from 1 V to 6V (vs. Li/Li⁺). The results are shown in FIG. 2. As shown in FIG. 2, the SPE1 sample of Example 1 has a wide electrochemical window, and a superior interfacial chemical stability with lithium metal.

### Application Example 1: Preparation of an all Solid-State Lithium Battery (LB_{E1})

The lithium ion conductive composite material of Example 1 was applied on a surface of a lithium foil having a diameter of 16 mm and a thickness of 0.45 mm to obtain an anode sheet.

Lithium iron phosphate (LFP, commercially available from Formosa Lithium Iron Oxide Corp., Taiwan), conductive carbon black Super P® (an average particle size: 30 nm, a specific surface area: 50 m²/g, commercially available from Timcal Ltd., Switzerland), vapor grown carbon fibers (VGCF, commercially available from Yonyu Applied Technology Material Co., Ltd., Taiwan), a lithium ion conductive composite material (a weight ratio of PVA/PAN to LiTFSI to LATP of 4:4:2), and SN were prepared at a weight ratio of 70:7.5:2.5:15:5. The lithium ion conductive composite material and SN were evenly stirred in DMSO solvent, followed by adding LFP, conductive carbon black Super P®, and VGCF, which were continuously stirred to obtain a mixture slurry material. The mixture slurry material was applied on an aluminum foil having a thickness of 20 μm, followed by baking in a vacuum oven at 70° C. to remove solvent and steam, followed by rolling using a roller to obtain a sheet having a thickness of about 49 μm (a surface density: about 4.1 mg/cm², a packing density: about 1.4 g/cm³), and then cutting the sheet to obtain a circular sheet having a diameter of 13 mm. A surface of the circular sheet opposite to the aluminum foil was applied with the lithium ion conductive composite material of Example 1 in an amount of 5 μL, thereby obtaining a cathode sheet.

The SPE1 sample of Example 1 was used as a solid polymer electrolyte composite membrane.

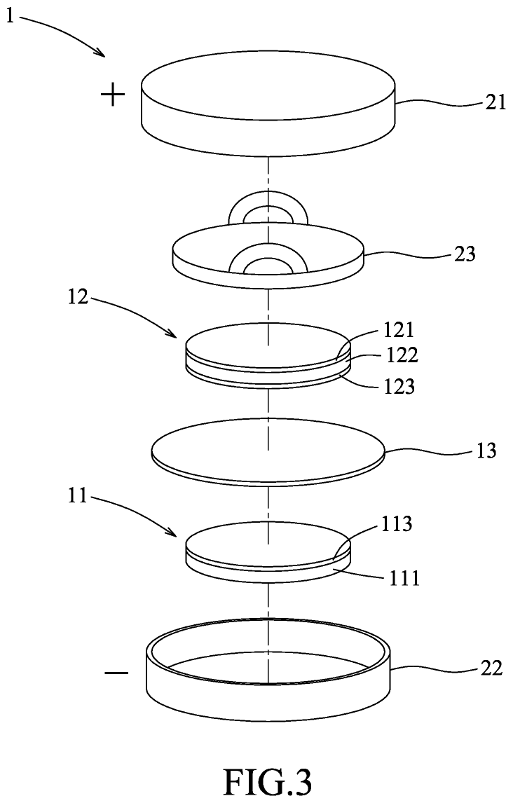

Referring to FIG. 3, an anode sheet 11 (i.e., the anode sheet prepared above, including the aluminum foil as an anode 111 and the lithium ion conductive composite material as a lithium ion conductive layer 113), a cathode sheet 12 (i.e., the cathode sheet prepared above, including an aluminum foil 121, a cathode 122, and the lithium ion conductive composite material as a lithium ion conductive layer 123), a solid polymer electrolyte composite membrane 13 (i.e., the solid polymer electrolyte composite membrane prepared above), and remaining components of a 2032 coil battery that includes a top cover 21, a bottom cover 22, and a spring 23, were packaged using a clamp in an argon atmosphere to obtain an all solid-state lithium battery 1 (denoted as LB_{E1}).

### Application Examples 2 and 3: Preparation of all Solid-State Lithium Batteries (LB_{E2} and LB_{E3})

The all solid-state lithium batteries (denoted as LB_{E2} and LB_{E3}) of Application Examples 2 and 3 were prepared according to the procedures of Application Example 1, except that lithium nickel cobalt aluminum oxide (LNCAO, commercially available from UbiQ Technology Co., Ltd., Taiwan) and lithium nickel cobalt manganese oxide (LNCMO811, commercially available from UbiQ Technology Co., Ltd., Taiwan) were used in Application Examples 2 and 3, respectively, to substitute for LFP in Application Example 1. The cathode sheet in the all solid-state lithium battery (LB_{E2}) of Application Example 2 had a sheet thickness of about 43 μm (a surface density: about 4.5 mg/cm², a packing density: about 2.0 g/cm³), and the cathode sheet in the all solid-state lithium battery (LB_{E3}) of Application Example 3 had a sheet thickness of about 40 μm (a surface density: about 4.6 mg/cm², a packing density: about 2.3 g/cm³).

### Application Examples 4 to 6: Preparation of all Solid-State Lithium Batteries (LB_{E4}, LB_{E5}, and LB_{E6})

The all solid-state lithium batteries (denoted as LB_{E4}, LB_{E5}, and LB_{E6}) of Application Examples 4 to 6 were prepared according to the procedures of Application Examples 1 to 3, respectively, except that the SPE3 sample of Example 3 was used as the solid polymer electrolyte composite membrane in each of Application Examples 4 to 6.

### Application Example 7: Preparation of an all Solid-State Lithium Battery (LB_{E7})

The all solid-state lithium battery (denoted as LB_{E7}) of Application Example 7 was prepared according to the procedures of Application Example 3, except that the SPE2 sample of Example 2 was used as the solid polymer electrolyte composite membrane.

### Application Example 8: Preparation of an all Solid-State Lithium Battery (LB_{E8})

Lithium hydroxide monohydrate (LiOH.H₂O, commercially available from Wako Pure Chemical Industries, Ltd.) was mixed with a Nafion solution (an amount of 5 wt % in a mixture solvent of aliphatic alcohol and water, commercially available from Sigma-Aldrich) in a weight ratio of the lithium hydroxide monohydrate to the Nafion solution of 1:17, followed by stirring at 60° C. for 2 hours and vacuum drying in an oven at 80° C. for 24 hours to obtain a so-called lithium-substituted Nafion (denoted as Li-Nafion). Li-Nafion was dispersed in N-methylpyrrolidone (NMP) to form a dispersion of Li-Nafion in NMP, and 5 μL of the dispersion was applied on an aluminum foil having a diameter of 16 mm and a thickness of 0.45 mm using a micropipette, such that a weight ratio of the active material in the cathode to Li-Nafion was 100:0.5, followed by drying at 55° C. for 24 hours and applying 5 μL of the lithium ion conductive composite material of Example 1 on Li-Nafion, so as to obtain an anode sheet.

A powdery material of LNCMO811 (as an active material of a cathode) was dispersed in a dispersion of Li-Nafion in NMP, followed by stirring at 60° C. for 2 hours, vacuum filtering, and drying under vacuum at 90° C. for 24 hours, so as to obtain a powdery material of LNCMO811 coated with a Li-Nafion layer.

The powdery material of LNCMO811 coated with Li-Nafion, conductive carbon black Super P®, VGCF, a lithium ion conductive composite material (a weight ratio of PVA/PAN to LiTFSI to LATP of 4:4:2), and SN were prepared at a weight ratio of 70:7.5:2.5:15:5. The lithium ion conductive composite material and SN were evenly stirred in DNSO solvent, followed by adding the powdery material of LNCMO811 coated with Li-Nafion, conductive carbon black Super P®, and VGCF, which were continuously stirred to obtain a mixture slurry material. The mixture slurry material was applied on an aluminum foil having a thickness of 20 μm, followed by baking in a vacuum oven at 70° C. to remove solvent and steam, followed by rolling using a roller to obtain a sheet having a thickness of about 40 μm (a surface density: about 4.6 mg/cm², a packing density: about 2.3 g/cm³), and then cutting the sheet to obtain a circular sheet having a diameter of 13 mm. A surface of the circular sheet opposite to the aluminum foil was applied with the lithium ion conductive composite material of Example 1 in an amount of 5 μL, thereby obtaining a cathode sheet.

The SPE1 sample of Example 1 was used as a solid polymer electrolyte composite membrane.

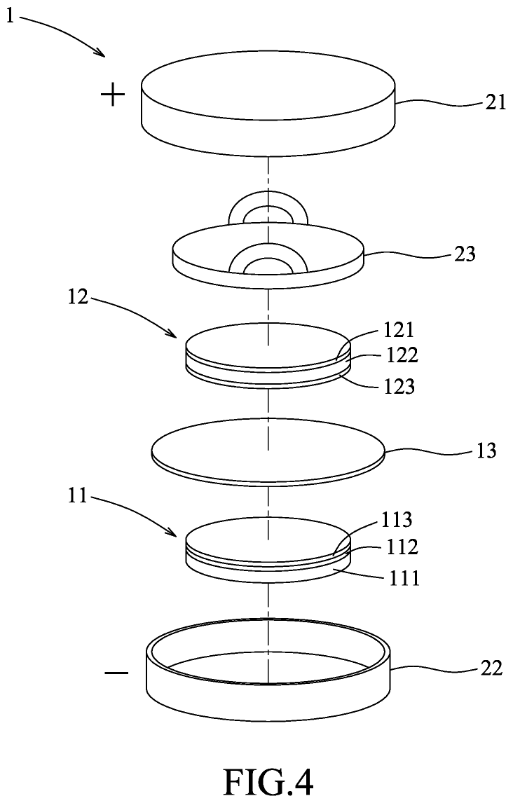

Referring to FIG. 4, an anode sheet 11 (i.e., the anode sheet prepared above, including the aluminum foil as an anode 111, Li-Nafion 112, the lithium ion conductive composite material as a lithium ion conductive layer 113), a cathode sheet 12 (i.e., the cathode sheet prepared above, including an aluminum foil 121, a cathode 122, and the lithium ion conductive composite material as a lithium ion conductive layer 123), a solid polymer electrolyte composite membrane (i.e., the solid polymer electrolyte composite membrane prepared above), and remaining components of a 2032 coil battery that includes a top cover 21, a bottom cover 22, and a spring 23, were packaged using a clamp in an argon atmosphere to obtain an all solid-state lithium battery 1 (denoted as LB_{E8}).

### Comparative Application Example 1: Preparation of a Lithium Ion Battery (LIB_{CE1})

A lithium foil having a diameter of 16 mm and a thickness of 0.45 mm was used as an anode sheet.

The circular sheet obtained in Application Example 1 was used as a cathode sheet.

A polyethylene separator (a thickness of 16 μm, commercially available from Asahi Kasei Corp., Japan), which was immersed in a 1 M solution of LiPF₆ in a mixture solvent of ethylene carbonate (EC) and diethyl carbonate (DEC) (a volume ratio of EC to DEC: 1:1), was used as an electrolyte membrane.

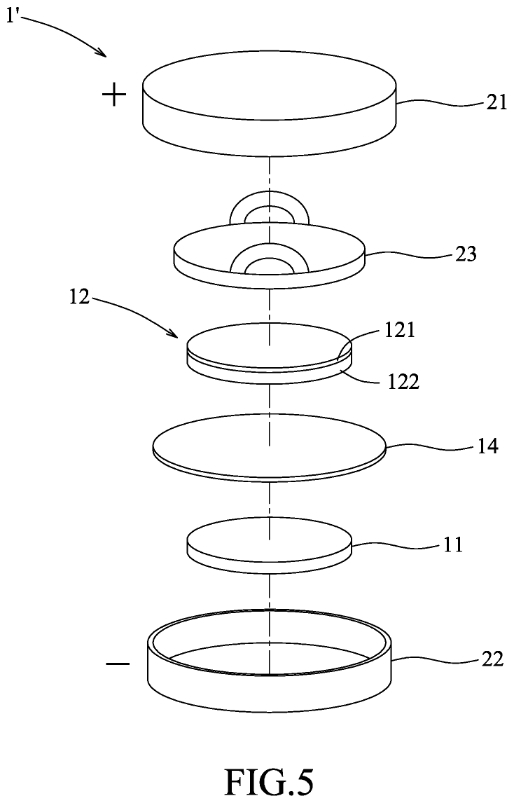

Referring to FIG. 5, an anode sheet 11 (i.e., the anode sheet prepared above), a cathode sheet 12 (i.e., the cathode sheet prepared above, including an aluminum foil 121 and a cathode 122), a separator 14 (i.e., the polyethylene separator prepared above), and remaining components of a 2032 coil battery that includes a top cover 21, a bottom cover 22, and a spring 23, were packaged in an argon atmosphere to obtain a lithium ion battery 1′ (denoted as LIB_{CE1}).

### Comparative Application Examples 2 and 3: Preparation of all Solid-State Lithium Batteries (LB_{CE2} and LB_{CE3})

The all solid-state lithium batteries (denoted as LB_{CE2} and LB_{CE3}) of Comparative Application Examples 2 and 3 were prepared according to the procedures of Application Examples 2 and 3, respectively, except that in the lithium ion conductive composite material of each of Comparative Application Examples 2 and 3, a weight ratio of PVA/PAN to LiTFSI to LATP to SN was 4:4:2:0.

### Measurement of Electrical Properties of all Solid-State Lithium Batteries and Lithium Ion Battery:

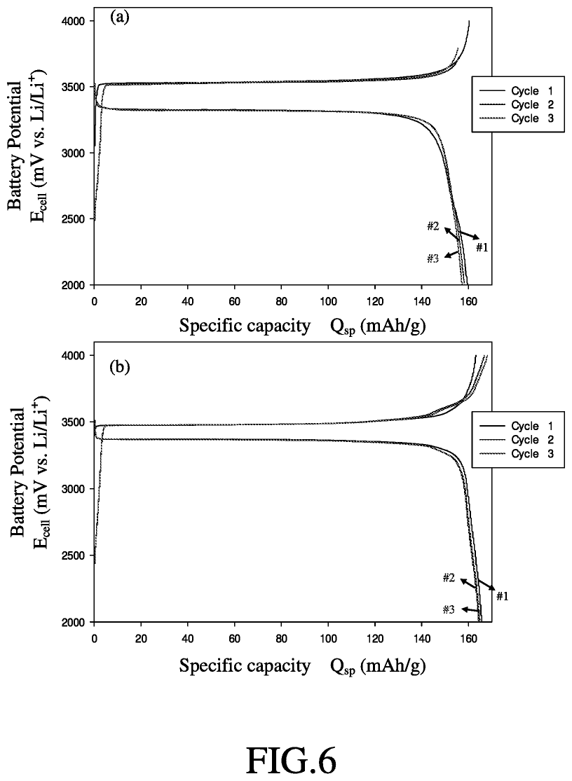

The charge/discharge specific capacity (Qₛₚ) of each of the all solid-state lithium batteries of Application Examples 1 to 8 and Comparative Application Examples 2 and 3, and the lithium ion battery of Comparative Application Example 1 was measured using a battery automatic tester (Model: BAT-750B, commercially available from Acutech Systems Co., Ltd., Taiwan) at a charge current of 0.1 C and a discharge current of 0.1 C. Coulombic efficiency (CE %) was calculated according to Equation 1 shown below, and discharge capacity retention (CR %) after 30 charge/discharge cycles was calculated according to Equation 2 shown below. The charge/discharge conditions during measurements and the thus obtained results are shown in Tables 2 to 5 below. Graphs illustrating charge/discharge specific capacity-potential relationship over 3 charge/discharge cycles for the all solid-state lithium battery of Application Example 1 are shown in FIG. 6, in which graph (a) represents the result determined at 25° C., and graph (b) represents the result determined at 60° C.

CE %=[(Qₛₚ)_{discharge,n}^{th}_{cycle}/(Qₛₚ)_{charge,n}^{th}_{cycle}]×100% (1)

CR %=[(Qₛₚ)_{discharge,30}^{th}_{cycle}/(Qₛₚ)_{discharge,1}^{st}_{cycle}]×100% (2)

TABLE 2

| | 25° C. | | | 60° C. | | |
|---|---|---|---|---|---|---|
| | | 3 cycles | | | 3 cycles | |
| | 1 cycle | Average | | 1 cycle | Average | |
| | (Qₛₚ) | (Qₛₚ) | | (Qₛₚ) | (Qₛₚ) | |
| | discharge | discharge | Average | discharge | discharge | Average |
| | (mAh/g) | (mAh/g) | CE % | (mAh/g) | (mAh/g) | CE % |
| LB_{E1} | Potential range: from 2.0 V to 4.0 V | | | | | |
| | (vs. Li/Li⁺), 1C = 170 mAh/g | | | | | |
| | 159.6 | 158.3 | 99.8% | 165.8 | 165.2 | 99.5% |
| LB_{E2} | Potential range: from 2.8 V to 4.3 V | | | | | |
| | (vs. Li/Li⁺), 1C = 200 mAh/g | | | | | |
| | 108.0 | 115.6 | 86.6% | 138.0 | 125.7 | 74.6% |
| LB_{E3} | Potential range: from 2.5 V to 4.3 V | | | | | |
| | (vs. Li/Li⁺), 1C = 200 mAh/g | | | | | |
| | 170.5 | 151.4 | 91.2% | 204.8 | 180.3 | 86.7% |
| LB_{CE2} | Potential range: from 2.8 V to 4.3 V | | | | | |
| | (vs. Li/Li⁺), 1C = 200 mAh/g | | | | | |
| | 110.4 | 109.5 | 87.3% | 121.8 | 105.9 | 29.4% |
| LB_{CE3} | Potential range: from 2.5 V to 4.3 V | | | | | |
| | (vs. Li/Li⁺), 1C = 200 mAh/g | | | | | |
| | 156.7 | 149.5 | 91.6% | 190.7 | 154.1 | 72.8% |

TABLE 3

| | 25° C. | | | 45° C. | | |
|---|---|---|---|---|---|---|
| | | 3 cycles | | | 3 cycles | |
| | 1 cycle | Average | | 1 cycle | Average | |
| | (Qₛₚ) | (Qₛₚ) | | (Qₛₚ) | (Qₛₚ) | |
| | discharge | discharge | Average | discharge | discharge | Average |
| | (mAh/g) | (mAh/g) | CE % | (mAh/g) | (mAh/g) | CE % |
| LB_{E4} | Potential range: from 2.0 V to 4.0 V | | | | | |
| | (vs. Li/Li⁺), 1C = 170 mAh/g | | | | | |
| | 156.5 | 156.2 | 99.7% | 158.6 | 158.1 | 97.9% |
| LB_{E5} | Potential range: from 2.8 V to 4.2 V | | | | | |
| | (vs. Li/Li⁺), 1C = 200 mAh/g | | | | | |
| | 166.2 | 164.7 | 92.4% | 184.1 | 186.2 | 90.7% |
| LB_{E6} | Potential range: from 2.5 V to 4.2 V | | | | | |
| | (vs. Li/Li⁺), 1C = 200 mAh/g | | | | | |
| | 150.9 | 152.4 | 97.3% | 193.8 | 170.6 | 87.0% |

TABLE 4

| | 25° C. | | | |
|---|---|---|---|---|
| | 1 cycle | 30 cycles | | |
| | (Qₛₚ) discharge | (Qₛₚ) discharge | Average | |
| | (mAh/g) | (mAh/g) | CE % | CR % |
| LB_{E1} | Potential range: from 2.0 V to 4.0 V | | | |
| | (vs. Li/Li⁺), 1C = 170 mAh/g | | | |
| | 159.6 | 157.2 | 100.0% | 98.5% |
| LBC_{E1} | Potential range: from 2.0 V to 4.0 V | | | |
| | (vs. Li/Li⁺), 1C = 170 mAh/g | | | |
| | 149.3 | 146.3 | 99.9% | 98.0% |

TABLE 5

| 25° C. | |
|---|---|
| 1 cycle | 3 cycles |

| | | |
|---|---|---|
| (Qₛₚ) discharge | Average (Qₛₚ) discharge | Average |
| (mAh/g) | (mAh/g) | CE % |

| | |
|---|---|
| LB_{E7} | Potential range: from 2.5 V to 4.2 V |
| | (vs. Li/Li⁺), 1C = 200 mAh/g |

| | | |
|---|---|---|
| 133.4 | 138.4 | 92.1% |

| | |
|---|---|
| LB_{E8} | Potential range: from 2.5 V to 4.2 V |
| | (vs. Li/Li⁺), 1C = 200 mAh/g |

| | | |
|---|---|---|
| 167.0 | 167.6 | 97.8% |

As shown in Table 2, after 3 charge/discharge cycles at 25° C. and 60° C., the average discharge specific capacity of the all solid-state lithium battery (denoted as LB_{E2}) of Application Example 2 is much higher than that of the all solid-state lithium battery (denoted as LB_{CE2}) of Comparative Application Example 2, and the average discharge specific capacity of the all solid-state lithium battery (denoted as LB_{E3}) of Application Example 3 is much higher than that of the all solid-state lithium battery (denoted as LB_{CE3}) of Comparative Application Example 3. After 3 charge/discharge cycles at 60° C., the average coulombic efficiency of the all solid-state lithium battery (denoted as LB_{E2}) of Application Example 2 is much higher than that of the all solid-state lithium battery (denoted as LB_{CE2}) of Comparative Application Example 2, and the average coulombic efficiency of the all solid-state lithium battery (denoted as LB_{E3}) of Application Example 3 is much higher than that of the all solid-state lithium battery (denoted as LB_{CE3}) of Comparative Application Example 3.

As shown in Table 4, after several charge/discharge cycles, the discharge specific capacity, the average coulombic efficiency, and the discharge capacity retention of the all solid-state lithium battery (denoted as LB_{E1}) of Application Example 1 are much higher than those of the lithium ion battery (denoted as LIB_{CE1}) of Comparative Application Example 1.

As shown in Tables 2 and 3, after 3 charge/discharge cycles at 25° C., the average discharge specific capacity and the average coulombic efficiency of the all solid-state lithium battery (denoted as LB_{E5}) of Application Example 5 are much higher than those of the all solid-state lithium battery (denoted as LB_{E2}) of Application Example 2. After 3 charge/discharge cycles at 25° C., the average discharge specific capacity and the average coulombic efficiency of the all solid-state lithium battery (denoted as LB_{E6}) of Application Example 6 are much higher than those of the all solid-state lithium battery (denoted as LB_{E3}) of Application Example 3.

As shown in Tables 2 and 5, after 3 charge/discharge cycles at 25° C., the average coulombic efficiency of the all solid-state lithium battery (denoted as LB_{E7}) of Application Example 7 is much higher than that of the all solid-state lithium battery (denoted as LB_{E3}) of Application Example 3. After 3 charge/discharge cycles at 25° C., the average discharge specific capacity and the average coulombic efficiency of the all solid-state lithium battery (denoted as LB_{E8}) of Application Example 8 are much higher than those of the all solid-state lithium battery (denoted as LB_{E3}) of Application Example 3.

In view of the aforesaid, the solid-state polymer composite electrolyte that includes the lithium ion conductive composite material according to the disclosure has superior thermal stability, high lithium ion conductivity at room temperature and elevated temperature, and a wide electrochemical window. The all solid-state lithium battery that includes the lithium ion conductive composite material according to the disclosure has high discharge specific capacity at room temperature and elevated temperature, high coulombic efficiency, and superior charge/discharge cycle stability (i.e., high discharge capacity retention).

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A lithium ion conductive composite material for an all solid-state lithium battery, comprising:
a polymer blend which includes polyacrylonitrile and a polyvinyl polymer selected from the group consisting of polyvinyl alcohol, poly(vinylidene fluoride-hexafluoropropylene), and a combination thereof;
a lithium salt;
a lithium ion conductive ceramic filler; and
a plasticizer.

2. The lithium ion conductive composite material according to claim 1, wherein said polyacrylonitrile is in an amount ranging from 5 wt % to 95 wt % and said polyvinyl polymer is in an amount ranging from 95 wt % to 5 wt % based on 100 wt % of said polymer blend.

3. The lithium ion conductive composite material according to claim 2, wherein said polyvinyl polymer is said polyvinyl alcohol, and said polyacrylonitrile is in an amount ranging from 5 wt % to 20 wt % and said polyvinyl alcohol is in an amount ranging from 95 wt % to 80 wt % based on 100 wt % of said polymer blend.

4. The lithium ion conductive composite material according to claim 2, wherein said polyvinyl polymer is said poly(vinylidene fluoride-hexafluoropropylene), and said polyacrylonitrile is in an amount ranging from 5 wt % to 20 wt % and said poly(vinylidene fluoride-hexafluoropropylene) is in an amount ranging from 95 wt % to 80 wt % based on 100 wt % of said polymer blend.

5. The lithium ion conductive composite material according to claim 1, wherein said polymer blend is in an amount ranging from 30 wt % to 40 wt % based on 100 wt % of a combination of said polymer blend, said lithium salt, and said lithium ion conductive ceramic filler.

6. The lithium ion conductive composite material according to claim 1, wherein said lithium salt is in an amount ranging from 30 wt % to 50 wt % based on 100 wt % of a combination of said polymer blend, said lithium salt, and said lithium ion conductive ceramic filler.

7. The lithium ion conductive composite material according to claim 1, wherein said lithium ion conductive ceramic filler is in an amount ranging from 1 wt % to 30 wt % based on 100 wt % of a combination of said polymer blend, said lithium salt, and said lithium ion conductive ceramic filler.

8. The lithium ion conductive composite material according to claim 1, wherein said plasticizer is in an amount ranging from 1 wt % to 40 wt % based on 100 wt % of said polymer blend.

9. The lithium ion conductive composite material according to claim 1, wherein said lithium salt is selected from the group consisting of lithium bis-trifluoromethanesulfonimide, lithium perchlorate, lithium trifluoromethanesulfonate, lithium bis(oxalato)borate, lithium tetrafluoroborate, and combinations thereof.

10. The lithium ion conductive composite material according to claim 1, wherein said lithium ion conductive ceramic filler is selected from the group consisting of lithium aluminum titanium phosphate, lithium aluminum germanium phosphate, lithium lanthanum zirconium oxide, aluminum-doped lithium lanthanum zirconium oxide, gallium-doped lithium lanthanum zirconium oxide, niobium-doped lithium lanthanum zirconium oxide, lithium lanthanum zirconium tantalum oxide, lithium lanthanum titanium oxide, lithium phosphorous oxynitride, and combinations thereof.

11. The lithium ion conductive composite material according to claim 1, wherein said plasticizer is selected from the group consisting of succinonitrile, adiponitrile, lithium azide, poly(ethylene glycol), poly(ethylene glycol) diacrylate, triallyl isocyanurate, and combinations thereof.

12. A solid polymer electrolyte for an all solid-state lithium battery, comprising the lithium ion conductive composite material according to claim 1.

13. An all solid-state lithium battery, comprising:
an anode;
a cathode;
a solid electrolyte composite membrane disposed between said anode and said cathode; and
a first lithium ion conductive layer which includes the lithium ion conductive composite material according to claim 1, and which is applied on one of said anode and said cathode so as to be sandwiched between said solid electrolyte composite membrane and said one of said anode and said cathode.

14. The all solid-state lithium battery according to claim 13, further comprising a second lithium ion conductive layer which includes the lithium ion conductive composite material according to claim 1, and which is applied on the other one of said anode and said cathode so as to be sandwiched between said solid electrolyte composite membrane and said other one of said anode and said cathode.

15. The all solid-state lithium battery according to claim 13, wherein said solid electrolyte composite membrane is the solid polymer electrolyte according to

16. The all solid-state lithium battery according to claim 13, wherein said cathode is made of a composition including an active material, an electron-conductive agent, and a binder.
